(19) United States
(12) Patent Application Publication
(10) Pub. No.: US 2017/0129029 A1
(43) Pub. Date: May 11, 2017

(54) THREAD MILLING CUTTER

(71) Applicant: WALTER AG, Tubingen (DE)

(72) Inventor: Daniel KUDERER, Zell a. H. (DE)

(21) Appl. No.: 15/317,873

(22) PCT Filed: May 12, 2015
(86) PCT No.: PCT/EP2015/060481

§ 371 Date: Dec. 9, 2016

(30) Foreign Application Priority Data
Jun. 13, 2014 (EP) 14172332.0

(51) Int. Cl. B23G 5/18

(52) U.S. Cl. CPC B23G 5/18; B23G 2200/10; B23G 2200/50

(57) ABSTRACT

A thread milling cutter having a main body which includes a shank and a cutting portion, which is cylindrical in its basic shape, an axis of rotation and a plurality of cutting teeth, which are spaced in the peripheral direction and which are arranged on the cutting portion in at least two different radial planes extending perpendicularly to the axis of rotation is provided. The thread milling cutter combines the advantages of high working efficiency of one-piece thread milling cutters having a plurality of cutting teeth and cutting lobes with the advantages of thread milling cutters having indexable cutting inserts without being restricted to large diameters. The cutting portion, respectively, has at least two seats for receiving a respective standard cutting insert in each of at least two different radial planes and the cutting teeth are formed by cutting corners of standard cutting inserts.

### RELATED APPLICATION DATA

This application is a §371 National Stage Application of PCT International Application No. PCT/EP2015/060481 filed May 12, 2015 claiming priority of EP Application No. 14172332.0, filed Jun. 13, 2014.

### TECHNICAL FIELD

The present disclosure concerns a thread milling cutter having a main body which includes a shank and a cutting portion, which is cylindrical in its basic shape, and an axis of rotation. A plurality of cutting teeth are spaced in the peripheral direction and are arranged on the cutting portion in at least two different (i.e., axially spaced) radial planes extending perpendicularly to the axis of rotation.

### BACKGROUND

The term “shank” is to be interpreted in functional terms and includes, in that respect, all kinds of thread milling cutters, which have a cutting portion and a one-piece or multi-piece holding portion (referred to herein as the “shank”), which is connected to the cutting portion and which in operation rotates jointly with the cutting portion.

A corresponding thread milling cutter is known for example from U.S. Pat. No. 5,733,078. In the known thread milling cutter, in an embodiment, there are provided two cutting inserts, which are disposed in a diametrally opposite relationship on a cylindrical portion and which each have two cutting teeth, which each have the profile of a thread flight. The cutting teeth of the two cutting inserts are arranged in a pair-wise relationship in two mutually axially spaced radial planes.

Corresponding thread milling cutters are intended for the production of female threads with a nominal radius, which is larger than the rotation radius of the cutting teeth in relation to the axis of rotation of the thread milling cutter. This means that, to produce a corresponding female thread, the milling cutter has to be moved with its axis of rotation extending parallel to the axis of the bore in a spiral configuration around the axis of the bore and axially into the same and/or out of the same, in which bore the thread is to be produced.

In general terms, the internal radius of the thread or the radius of the bore in which the thread is to be produced is markedly larger than the radius of the rotation circle of the cutting teeth so that the milling cutter can be moved into or out of the bore axially in the center of the bore without the cutting teeth touching the wall of the bore.

Thus, the milling cutter can firstly be caused to move by a distance into the bore without the cutting teeth touching the walls of the bore and then the milling cutter is caused to rotate and moved radially outwardly and at the same time moved with an axial feed along a spiral path around the axis of the bore so that the cutting teeth come into contact with the wall of the bore and mill the thread into the wall of the bore by virtue of the movement of the entire milling cutter on a corresponding helical line.

Depending on the feed movement and the spacing of the radial planes with cutting teeth it is possible to produce threads involving different pitches and in the case of bores whose diameter is larger than the diameter of the rotation circle of the cutting teeth it is also possible to produce a plurality of portions of a thread in each case by different cutting teeth arranged in axially displaced relationship.

There are corresponding milling cutters, as the state of the art in accordance with the above-mentioned U.S. Pat. No. 5,733,078 also shows, both in the form of one-piece tools whose cutting teeth are formed directly from the material of the cutting portion and also in the form of tools with cutting inserts which are interchangeable and which are fitted especially with suitable cutting teeth which correspond to a thread profile.

One-piece thread milling cutters suffer from the disadvantage that after wear of the cutting teeth the milling cutter can only be limitedly refurbished again, in which case the cutting portion also has to be produced from a correspondingly wear-resistant material, generally a cemented carbide or sintered carbide, and are possibly to be coated, and are thus very expensive both in terms of provision and also refurbishing. The thread milling cutters with cutting inserts in turn suffer from the disadvantage that only relatively little space is available for providing suitable insert seats along the periphery of a cutting portion which is cylindrical in its basic shape, if sufficient stability is to be ensured for the cutting portion, so that the number of corresponding cutting inserts is relatively limited and thus the thread milling cutter operates less effectively than a one-piece thread milling cutter equipped with a plurality of cutting lobes and cutting teeth.

A further disadvantage of the thread milling cutters with interchangeable indexable cutting inserts is that the corresponding indexable cutting inserts are frequently expensive special productions.

On the other hand, the advantage of the thread milling cutters with interchangeable cutting inserts lies precisely in the interchangeability of worn cutting inserts, which even in their totality are substantially less expensive than a one-piece tool and which also make it possible to produce the main body, that is to say, the shank and the cutting portion of the thread milling cutter, from a less expensive material, which is easier to machine, for example, tool steel.

In addition, state of the art thread milling cutters, which are already known, have a shank having a cutting portion, wherein the cutting portion comprises a receiving mandrel and a plurality of cutting rings and spacer rings disposed therebetween, wherein each cutting ring has a plurality of cutting teeth in the same plane.

Such a milling cutter however suffers from the disadvantage that the central mandrel of the cutting portion, which in practice alone ensures stability, is of a diameter which is small in comparison with the overall diameter of the milling cutter, and thus is of comparatively low stability because corresponding cutting rings like the spacer rings are inevitably of considerable radial dimensions, which take up a large part of the diameter of the cutting portion. Such thread milling cutters are therefore limited to very large thread diameters. They are also extraordinarily complicated in production and also precise radial and axial positioning of the cutting corners requires a considerable amount of expenditure and complication in the production of a corresponding multi-part cutting portion.

### SUMMARY

The aim of the present disclosure is to overcome these disadvantages by providing a thread milling cutter having the features set out in the opening part of this specification, which combines the features of the high working efficiency of one-piece thread milling cutters having a plurality of cutting teeth and cutting lobes with the features of thread milling cutters with indexable cutting inserts without being limited to large diameters.

That object is attained in that the cutting portion respectively has at least two seats for receiving a respective standard cutting insert in each of at least two different radial planes and the cutting teeth are formed by cutting portions and/or cutting corners of standard cutting inserts.

The cutting corners of numerous standard cutting inserts, in particular cutting inserts which are triangular in plan view, already correspond to the profile of many standard threads with thread flanks, which are inclined substantially at 60° relative to each other, wherein the peaks of the corner regions of such cutting inserts are generally also rounded or beveled, which again corresponds to the shape of a usual thread base. In particular cutting inserts, which are offered in catalogs from the manufacturers as stock items and which have a top side and an underside with a peripherally extending edge surface joining the top side and the underside, are viewed as standard cutting inserts. The top side (in the case of double-sided inserts also the underside) in that case forms a rake face and can possibly also be structured. Apart from suitable structuring configurations for chip formation or for delimiting chip-engaging faces in relation to support faces, the top side and the underside of standard cutting inserts are substantially parallel (see for example Walter AG, overall catalog 04/2004, pages 14, 15 and 16, indexable cutting inserts for turning and thread turning). Preferably in a plan view on to the top side those cutting inserts are of a triangular, rhombic, generally parallelogram-shaped or also rectangular basic shape.

Standard cutting inserts of other basic shapes, however can also be suitable for special thread shapes and profiles or respectively have cutting corners whose shape corresponds to a thread profile. Standard cutting inserts are accordingly also suitable and intended for other purposes of use, they can be individually exchanged, and they are not limited to use on the above-defined thread milling cutter of the present invention.

Standard cutting inserts are in particular defined by the international standard ISO 1832. In that respect, all insert forms are suitable for use in conjunction with the present invention, but insert shapes in which the cutting edges adjoining a cutting corner include an angle ≦90° are preferred, in particular the basic shapes identified by C, D, E, K, M, T, V and W in accordance with ISO 1832 are suitable for the production of threads, wherein the triangular shape identified by T is particularly useful.

The fact that corresponding insert seats are arranged in a plurality of mutually axially spaced radial planes means that the number of cutting corners producing the thread can be correspondingly increased, which improves the efficiency of the milling cutter, and the use of standard cutting inserts is found to be highly cost-efficient. In that respect the standard cutting inserts can possibly also be slightly modified, for example to adapt the cutting corners to given thread shapes, without thereby substantially increasing the costs involved in manufacture of corresponding cutting inserts.

At least three cutting inserts are respectively arranged on the same rotation circle in a radial plane so that each thread portion is produced during rotation of the milling cutter by at least three cutting corners of the three different cutting inserts. In addition, corresponding cutting inserts are arranged in overall at least three different radial planes, which means that the cutting inserts of a respective radial plane can produce respectively different portions of a thread, wherein the cutting inserts of a respective radial plane in the case of cutting inserts in three different planes respectively produce a third of a thread and wherein the spacing of the radial planes is adapted to the desired feed movement or also different feed rates of the thread milling cutter in the manufacturing procedure so that the thread flights produced by the cutting inserts in various radial planes open exactly into the corresponding thread flights produced by cutting inserts of adjacent radial planes. The axial feed of the milling cutter per revolution on the spiral path around the axis of the bore basically corresponds in that case to the respective thread pitch.

In an embodiment of the disclosure, three cutting inserts are respectively arranged in five different radial planes, which are at an axial spacing of about 12 mm relative to each other, which makes it possible to produce various threads with standard thread pitches of 1 mm, 1.5 mm, 2 mm, 3 mm, 4 mm and 6 mm, with one and the same milling cutter.

In an embodiment the cutting inserts of different and in particular adjacent radial planes are arranged in mutually displaced relationship in the peripheral direction. A corresponding displacement of the cutting inserts in adjacent radial planes provides that the cutting inserts in adjacent radial planes come into engagement with the wall of the bore in time-displaced relationship, which leads to smooth, low-vibration running of the milling cutter and minimization of the deflection forces acting on the milling cutter.

In an embodiment of the disclosure, provided in front of the rake faces of the cutting inserts or cutting corners are chip spaces formed by cavities which are set back radially with respect to the cylindrical envelope of the cutting portion.

The displacement of the mutually closest cutting inserts of adjacent radial planes in the peripheral direction desirably corresponds to a twist angle which is so selected that the chip spaces of the mutually closest cutting inserts arranged in adjacent radial planes overlap in the peripheral direction. This means that the chip spaces of cutting inserts which follow each other in the axial direction and which are slightly displaced relative to each other in the peripheral direction approximately follow the path of a spiral-shaped chip groove, the twist angle of which arises out of the axial spacing and the displacement of the cutting inserts relative to each other.

Desirably, the cutting insert of a following plane is set back with respect to the closest cutting insert of a preceding cutting plane in the direction of rotation of the milling cutter. In that respect, the reference to the preceding radial plane is used to mean the radial plane which is axially further forwardly, that is to say further remote from the shank.

Such angular displacement is of a magnitude which corresponds to the peripheral angle spacing of the cutting inserts in the same radial plane divided by the number of various radial planes in which cutting inserts are disposed.

This provides that, during the rotation of the milling cutter, there is at most a respective single cutting insert in maximum engagement with the wall of the bore while other cutting inserts are disposed shortly before maximum engagement or shortly after maximum engagement with the bore wall. This provides for operation of the milling cutter, which is as constant and as vibration-free as possible during use thereof.

The spacing of the radial planes can be an integral multiple of a standard thread pitch. In particular, the spacing of the radial plane is a common integral multiple of a plurality of standard thread pitches.

The amount of the standard thread pitches for which the spacing of the radial planes is an integral multiple of a standard thread pitch includes the values of 1 mm, 1.5 mm, 2 mm, 3 mm, 4 mm and 6 mm per turn or 1/32, 1/16, ⅛ and ¼ inch per turn.

In an embodiment, the spacing of the radial planes is 12 or 24 mm, but in that respect spacings of the radial planes of 6, 15, 18, 30, 36, 42 or 48 mm (alternatively also 4 inches, 3 inches, 2 inches, 1½ inches, 1 inch, ¾ inch, ½ inch or ¼ inch) are also suitable for respectively producing a plurality of standard thread pitches with a corresponding milling cutter so that these spacing values also represent preferred embodiments of the present invention.

Preferred standard cutting inserts are in particular cutting inserts, which each have an at least approximately mutually parallel top side and underside as well as a peripherally extending edge surface between the top side and the underside and which in a plan view on to the rake face involve the basic shape of an equilateral triangle and which are radially mounted in their respective seat, that is to say the cutting edges forming the cutting corner are disposed approximately in a plane containing the axis, wherein however the plane defined by the cutting edges of the cutting corner can also be slightly tilted relative to such a plane containing the axis, for example through an angle of up to ±20°, and wherein in particular for double-sided indexable cutting inserts a slight tilt of the plane of the cutting edge relative to a plane containing the axis is absolutely necessary to ensure a suitable relief angle.

Corresponding triangular cutting inserts have have three usable cutting corners and after wear of one of the corners can be turned through 120° and re-fitted in their seat. As already mentioned, the tips of those cutting corners can be rounded or beveled or trimmed back so that the corners correspond to the profile shape of a usual thread flight.

In that respect, however slight, modifications in corresponding cutting inserts are also intended to be embraced by the scope of protection of the present disclosure, which can be easily produced by modification of the cutting inserts which of a triangular basic shape. That includes, in particular, cutting inserts in which the side faces are slightly drawn in, in the direction of the center, or are expanded, which leads to a corresponding variation in the flank angle of the cutting corners so that the two cutting edges flanking the cutting corner include an angle of somewhat less than 60° or somewhat more than 60° and flank angles for example between 45° and 90° can be covered.

It is further possible for a flank of a cutting corner to be displaced by way of a step at one or both sides somewhat inwardly in order for example to smooth the radially inwardly furthest projecting land of the thread flights of the corresponding female thread or to mill same to an exactly defined radius. Examples of corresponding variations in the cutting corners are shown in FIG. 6.

To produce a multi-flight, for example a two-flight, thread the milling cutter according to the invention in an embodiment could also already be moved on a spiral path during movement into the bore so that the cutting teeth which are axially furthest forwardly come into engagement with the bore wall immediately and produce a corresponding thread flight. The axial spacing of the radial plane of a further set of cutting inserts is in that case so selected that, with a given thread pitch, the further set of cutting inserts cuts a thread flight between the thread flights which have already been produced. Conversely it could also be said that, with a given spacing in respect of the radial planes with cutting inserts, the thread pitch is so selected that parallel thread pitches are produced. With such a milling cutter the spacing of the radial planes which produce different (parallel) thread flights correspond to an integral multiple, in particular an odd-numbered multiple, of a fraction 1/n of the thread pitch, wherein n is the number of various parallel thread flights while the axial feed of the milling cutter per spiral revolution basically always corresponds to the respective thread pitch. Such a variant can be appropriate for example in relation to through bores when the idle mode of at least one respective set of cutting portions at the beginning and towards the end of the milling operation is less significant and all radial planes can be moved over the full thread length, in which case an axial spacing which is as short as possible between the radial planes is advantageous. A milling cutter with at least two radial planes at a 6 mm axial spacing respectively could thus produce a two-flight thread with a 4 mm thread pitch.

In an embodiment, the cutting inserts are double-sided indexable cutting inserts, which in the case of triangular cutting inserts gives in total six cutting corners which can be used in succession. The cutting inserts preferably have a central fixing bore and the side faces of the cutting inserts preferably serve as contact faces so that upon fixing of the cutting inserts in their seat by means of fixing screws which engage through the bore the position of the respectively active cutting corner is exactly defined by the contact of the contact faces against the corresponding seat faces. In that case when the contact faces bear against the corresponding seat faces of the insert seat the axes of the bore of the indexable cutting insert and the threaded bore into which a corresponding fixing screw engages can be slightly displaced relative to each other so that when the fixing screw is tightened the contact faces are pressed firmly against the corresponding seat faces.

It should be appreciated that the insert seat can also have corresponding undercut configurations for receiving non-active cutting edges or corners. In addition, the cutting inserts may have on the side opposite the rake face or on both sides, corresponding flat contact faces for bearing against a corresponding flat seat face of the insert seat, which also has the fixing bore for fixing the cutting insert. When using double-sided indexable inserts however the plane of the cutting corners, more precisely the cutting edges defining the cutting corners, must be inclined with respect to a plane extending through the cutting tip and containing the axis of rotation to ensure a necessary relief angle for the cutting corners. Here the radially furthest outwardly disposed point (apex) of the cutting corner is referred to as the cutting tip.

In a preferred embodiment of the present disclosure, the support face of the insert seat, which accommodates the contact face of the cutting insert, that is opposite to the rake face, extends radially outwardly beyond the cylindrical envelope of the cutting portion which is defined by the cylindrical basic shape of the cutting portion without the support face portion extending beyond same. Such a part of the support face, which extends radially beyond the cylindrical envelope of the cutting portion can be afforded in particular by the end face of a web, which peripherally extends at the periphery of the cutting portion in a radial plane, for example of triangular cross-section, wherein the peripherally extending web is respectively interrupted in the region of an insert seat and the chip space arranged in front of same in the direction of rotation. In that case the cross-section of the web should be set back somewhat in relation to the profile of the cutting corner arranged in front thereof so that the flanks of the web, which are moved in the thread milling operation behind a cutting corner through the thread flight produced do not come into contact with the thread flanks.

In addition, another embodiment of the present disclosure is one in which the seats of the indexable cutting inserts in the radial plane, which is furthest forwardly, are of such a configuration that the rotational circle of the active cutting tips or cutting teeth of the indexable cutting insert is somewhat larger than the rotational circle of the cutting teeth following in the axial direction. That radial projection is typically in the region of 1 to 100μ and depends in particular on the axial length of the cutting portion and its diameter and thus on the flexural stiffness and stability of the milling cutter and also the corresponding clamping means. That serves to compensate for radial deflection of the milling cutter in operation.

Optionally the cutting teeth of the second and third radial planes following the front radial plane can also have a (somewhat smaller) radial projection in relation to the cutting teeth of the respective following planes if particular precision of the overall thread is an important aspect.

The cutting inserts, which are axially furthest forwardly, preferably also have cutting edges, which are inclined relative to the axis of the milling cutter and which extend radially further inwardly in relation to the cutting corners producing the thread profile, wherein that front cutting edge is axially exposed, that is to say projects axially with respect to the milling cutter main body, and can be used inter alia for chamfering edges, in particular at the edge of the opening of a thread bore. The chamfering operation can optionally be effected prior to or after the step of milling the thread, the former being preferred.

Further advantages, features and possible uses of the present invention will be apparent from the description of preferred embodiments with reference to the accompanying figures.

### BRIEF DESCRIPTION OF THE DRAWINGS

FIG. 1 shows a side view of a thread milling cutter according to the invention.

FIG. 2 shows a view on an enlarged scale of the cutting portion of the milling cutter of FIG. 1 without cutting inserts.

FIG. 3 shows an end view from below of the cutting portion of FIG. 2.

FIG. 4 shows a sectional view containing the axis of the milling cutter.

Fig. shows a sectional view perpendicular to the axis along a radial plane containing the cutting tip.

FIG. 6 shows various variants of cutting corners.

### DETAILED DESCRIPTION

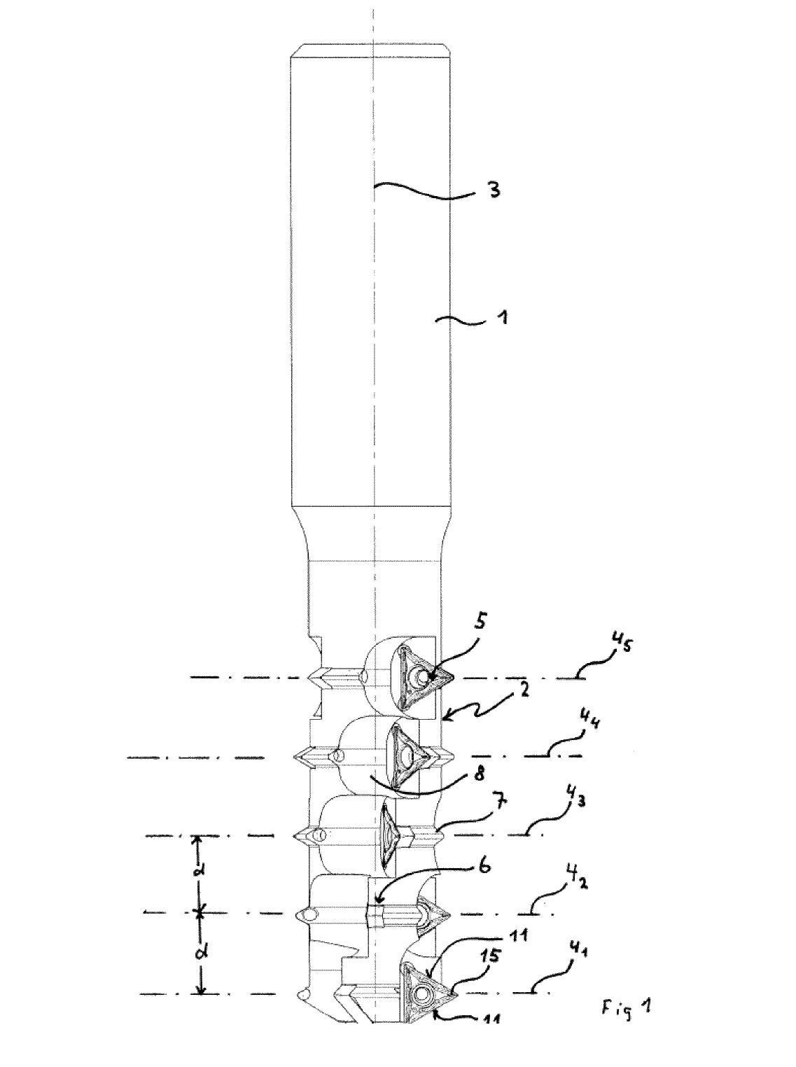

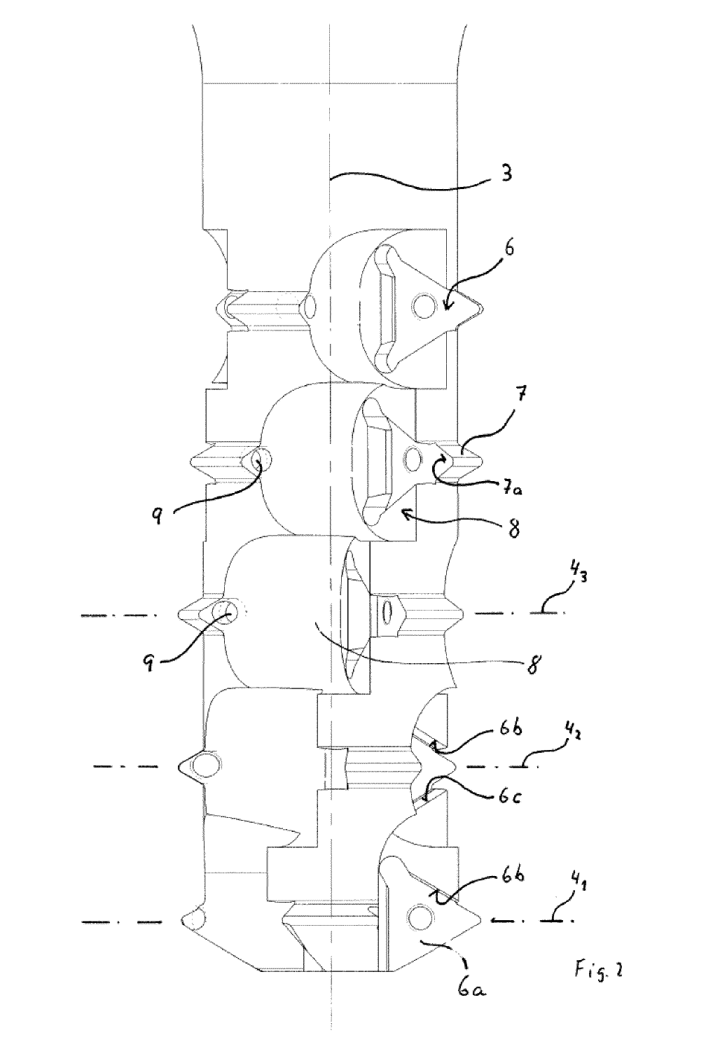

Referring to FIG. 1, the main body of a milling cutter includes a substantially cylindrical shank 1 and a substantially cylindrical cutting portion 2, which are assembled together in one piece and have a common axis of rotation 3, which is also the axis of symmetry of the shank 1 and the cylindrical envelope of the cutting portion 2, wherein the cylindrical envelope of the cutting portion 2 is defined only by the cylindrical portion outside cutting insert seats and chip spaces and without the peripherally extending webs 7, which serve to support the cutting tip of individual cutting inserts 5.

The cutting inserts 5 are standard cutting inserts in the basic shape of an equilateral triangle with a correspondingly triangular top side and an underside substantially parallel thereto, which are connected together by peripherally extending edge faces. At the transition between the edge faces and the top side (in the case of double-sided indexable inserts also the underside) there are formed respective cutting edges. In the plan view of the top side and the underside respectively, the cutting edges come together at cutting corners 15, wherein the cutting corners 15 are formed by the end portions of the cutting edges, which come together at the corners of a triangle of the cutting insert and a rounded transition therebetween. The flanks of the cutting corners include with each other an angle of 60° that is usual for thread flanks.

It should be appreciated that deviations from that 60° angle are possible insofar as the top side and the underside are of a shape differing from the shape of an equilateral triangle, for example by constricting or expanding the edge faces in the direction towards or away from the center of the cutting insert respectively. A respective central fixing bore is disposed in the center of each of the cutting inserts.

Insofar as this makes it easier to describe various cutting inserts 5 and radial planes 4, reference numerals 5 and 4 respectively are provided with additional indices.

FIG. 2 shows the cutting portion 2 without cutting inserts so that the seats 6 of the cutting inserts can be better seen, which are respectively defined by a base face 6a and by lateral contact faces 6b and 6c, wherein in the case of the insert seats, which are arranged furthest forwardly on the cutting portion 2, the lateral contact faces 6c are omitted so that cutting inserts 5 which are arranged in the front row of insert seats 6 are exposed with their entire front cutting edge 11 between two cutting corners so that those cutting edges can be used inter alia for chamfering edges, in particular at the edge of the opening of a thread bore. The chamfering operation can be effected optionally prior to or after milling of the thread, the former being preferred.

The space in front of the respective insert seat 6 is in the form of a chip space 8 and forms a respective recess in the cylindrical main body of the cutting portion 2. Provided in the region between insert seats and chip spaces on the outside of the cutting portion are peripherally extending webs 7 whose profile approximately corresponds to the profile of the cutting corners and which are arranged in the same radial plane as the cutting corners 15. In the region of the insert seats 6 the respective end faces of the webs 7 form a contact face 7a which is disposed in the same plane as the base face 6a of the insert seat 6 and thus forms a part of the seat face 6a.

Bores 9 optionally open on the rear side of the respective webs 7, that is towards the respective chip space 8, the bores 9 being provided for the discharge of a flushing and/or cooling agent which is injected in the direction of the cutting tips 15 into the chip spaces 8, which are in front of the cutting tips 15.

The webs 7 provide for effective support for the cutting tips 15, wherein the profile of the webs 7 should be slightly set back with respect to the profile of the cutting tips.

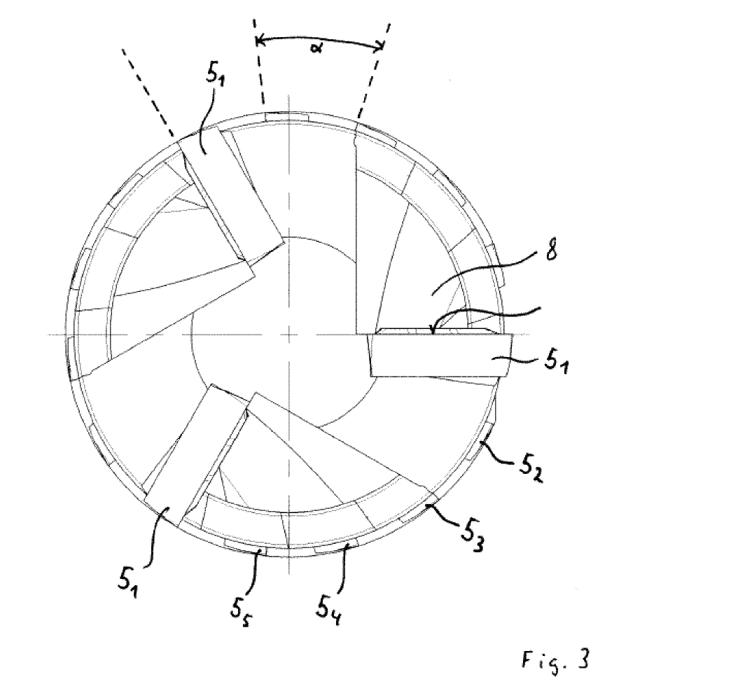

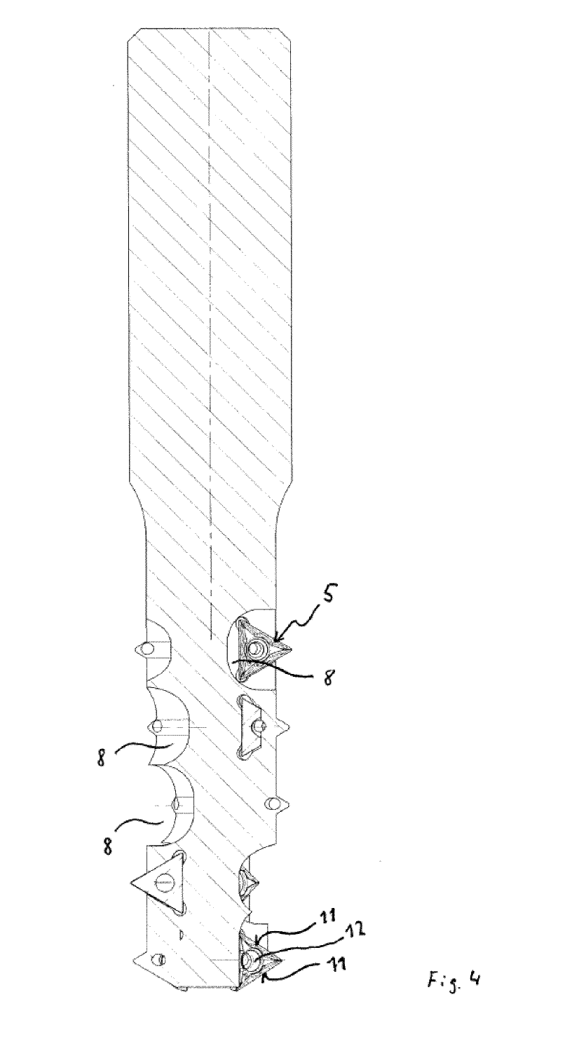

The end view in FIG. 3 shows three cutting inserts in the furthest forwardly disposed radial plane 4₁, the reference numerals of which are provided with the index 1 to distinguish the cutting inserts in subsequent planes. The cutting inserts in the subsequent planes 4₂ . . . 4₅ are correspondingly denoted by 5₂ . . . 5₅.

As can be seen from FIG. 3 and also FIG. 2, the cutting insert seats 6, like the cutting inserts 5 of a plane directly following the respectively preceding plane, are set back in opposite relationship to the direction of rotation through an angle α which in the present case is 24°. In that respect, the direction of rotation arises out of the arrangement of the cutting inserts and the chip spaces 8 arranged in front of same in the direction of rotation.

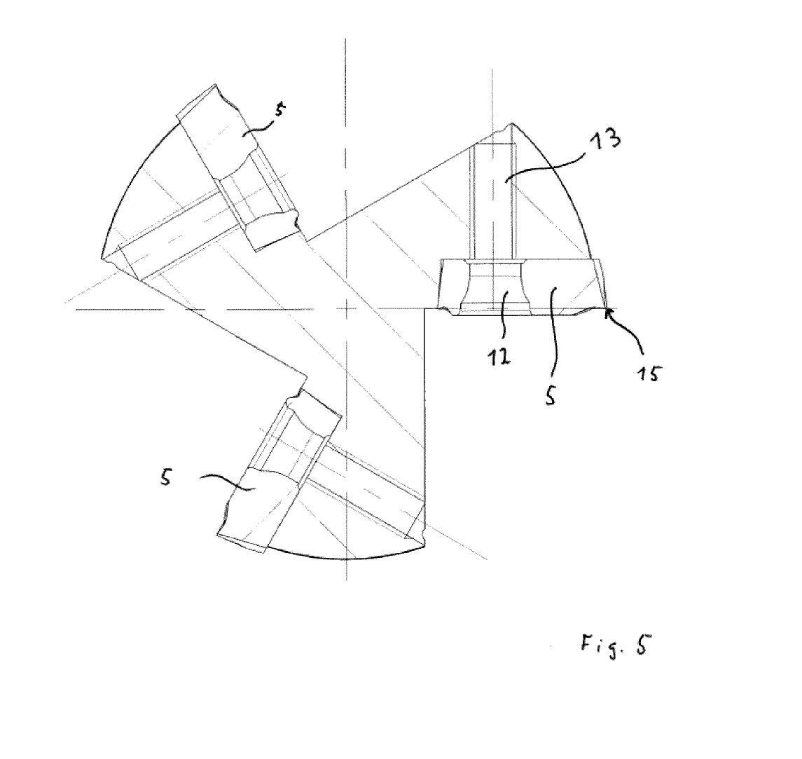

It should be appreciated that the angular displacement between cutting inserts of adjacent planes can also assume any other values, in which respect it is desirable for the cutting inserts overall to be so arranged that, at any moment during rotation of the milling cutter in a bore hole, the at least approximately equal number of cutting inserts should as far as possible always be in engagement at the same time with the wall of the hole and mills out a corresponding portion of a thread flight. As in the present case, the cutting inserts are distributed over 5 different radial planes 4 the displacement between adjacent radial planes 4 is a fifth of the peripheral spacing (120°) between cutting inserts in the same radial plane 4 so that the cutting inserts 5 are overall distributed uniformly along the periphery. That ensures relatively vibration-free and smooth running of the milling cutter in operation. FIG. 4 is a cross-sectional view, containing the axis of rotation 3, of the milling cutter already shown in FIGS. 1 through 3, with three respective cutting inserts in five different radial planes and with a displacement of the cutting inserts along a notional twist angle in the manner already just described. This view shows the chip spaces 8, which are respectively provided in front of the cutting inserts, and which extend in the peripheral direction of the cutting portion 2 over about 90°.

Similarly to the cutting inserts 5, the chip spaces 8 are also arranged in mutually displaced relationship along the same twist angle and they thus have respective regions overlapping each other in the peripheral direction so that the sequence of chip spaces 8 overall forms a kind of continuous chip flute, but with a correspondingly non-flat base and stepped transitions. That can be advantageous in particular in relatively narrow bore holes in which the diameter of the hole and the thread to be produced are only slightly larger than the diameter of the rotational circle of the cutting tips, because in that way the chips produced in the milling operation can also be transported further in the axial direction between the individual spaces and out of the bore hole. In that respect, it would further be possible for the transitions between adjacent chip spaces to be still further flattened off and smoothed so that the impression and also the effect of a chip flute is still further improved.

The radial sectional view in FIG. 5 again shows three cutting inserts 5 arranged in a radial plane 4 with chip spaces 8 in front of same. In addition, it is possible to see threaded bores 13 in the seat face 6a of the insert seat, which are not completely aligned with the through bores 12, so that when a corresponding clamping screw which engages into the threaded bore 13 is tightened the cutting inserts 5 are brought into fixed contact not only with the base face 6a of the insert seat but also with the lateral contact faces 6b and 6c.

The cutting inserts used in the present embodiment are one-sided indexable cutting inserts with a positive cutting geometry, specifically a wedge angle of less than 90° at the cutting edge 11 between the relief face and the rake face, wherein the rake face can also be structured by chip forming grooves, chip breakers and the like.

The cutting inserts 5 and their seats 6 can then be so arranged in particular that the cutting edges 11 are disposed substantially in a plane containing the axis of rotation 3.

The number of cutting inserts, which are arranged in a respective radial plane should be at least 2 so that female threads can be correspondingly quickly and efficiently produced with such a milling cutter. The number of cutting inserts per radial plane can also be greater than 3, in particular for milling cutters of larger diameter which also produce threads of correspondingly large diameter, in other respects however the number of cutting inserts is limited by the necessary maintenance of stability of the milling cutter or the cutting portion respectively and the size of the available standard cutting inserts.

As the provision of insert seats and chip spaces necessarily reduces the cross-section of the cutting portion and limits the stability or flexural strength of the cutting portion an embodiment of the disclosure can provide that the cutting tip of axially further forwardly disposed cutting inserts, in relation to the cutting tips of axially further rearwardly cutting inserts, that is to say, which are closer to the shank, is in each case larger by some micrometers than in the radial plane next following towards the shank. That takes account of the fact that, in a thread milling operation, the furthest forwardly disposed portions of the milling cutter or the cutting tips thereof are displaced slightly radially inwardly.

The spacing d between adjacent radial planes 4₁, 4₂ . . . 4₅ in the present embodiment is 12 mm and is thus a common integral multiple of 1; 1.5; 2; 3; 4 and 6. That makes it possible, using such a thread milling cutter as is shown in FIG. 1, to produce different threads with the thread pitches 1; 1.5; 2; 3; 4 and 6, in which case the three cutting inserts of each radial plane respectively produce a thread portion of a 12 mm axial length and with a suitable forward feed movement the thread flights produced by the cutting inserts 5₁, 5₂ . . . 5₅ run into each other in accurately fitting relationship. The overall thread length is then 60 mm. Threads using inch sizes are to be produced in an entirely similar fashion, wherein in the case of single-flight threads the spacings of the radial planes for producing threads using inch sizes respectively correspond to an integral multiple of the thread pitch expressed in inches. In this case too, once again spacings in respect of the radial planes which are a common integral multiple of a plurality of standard thread pitches (with inch sizes) are preferred.

It should be appreciated that the number of radial planes occurring in succession in the axial direction, with cutting inserts, can also be varied, but like the number of cutting inserts in a radial plane should be at least two. The efficiency of a corresponding thread milling cutter, that is to say the number of threads of a predetermined length, which are produced therewith per unit of time, rises with the number of cutting inserts per radial plane and the number of radial planes in which cutting inserts are provided.

In operation, for example, the milling cutter shown in FIG. 1 is firstly engaged into a suitably prepared bore to such an extent that the cutting tips of the cutting inserts of the furthest axially set-back radial plane 4₅ are disposed approximately in the region of the bore opening while the portion of the cutting portion is engaged into the bore, with the other cutting inserts in the radial planes 4₁ to 4₄. Then (or also already before or during engagement into the bore) the milling cutter is set in rotation and is then displaced radially outwardly until the cutting teeth come into engagement with the wall of the bore and begin to produce a respective portion of a thread flight, whereupon the entire milling cutter is moved in a spiral around the axis of the bore and in that case at the same time axially in accordance with a desired thread pitch in the forward direction until the cutting teeth of an axially following radial plane reach in precisely fitting relationship the thread flights produced by the teeth of the axially previous radial plane, whereupon the milling cutter is again centered with respect to the axis of the thread bore and axially withdrawn. In that way, a thread is produced of a depth, which, in the case of single-flight threads, corresponds to n-times the spacing between the radial planes, wherein n is the number of various radial planes with cutting inserts.

The thread milling cutter shown in the present figures have a considerably increased level of effectiveness in comparison with the thread milling cutters discussed in the Background, and at the same time can be used in highly versatile fashion, and can also be produced with relatively small rotational circle diameters in respect of the thread tips of for example 30 mm, and is in that respect relatively inexpensive in operation by virtue of the use of standard cutting inserts. For producing female threads of markedly smaller diameters than 30 mm firstly the number of cutting inserts per radial plane is to be reduced while the number of cutting inserts arranged in various radial planes in the axial direction is ultimately limited only by the thread lengths to be produced.

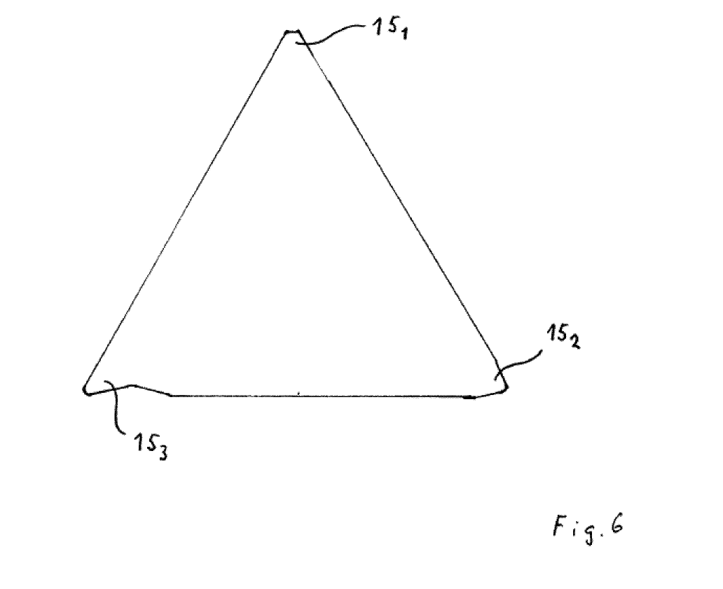

FIG. 6 shows various shapes of conceivable cutting corners which here are shown on a single cutting insert 5′, in which respect it should be appreciated that generally cutting inserts are uniformly provided with the same respective cutting corners as the cutting seats must be matched to the shape of the cutting corners in order to produce a given desired thread.

The cutting corner 15₁ is of a substantially trapezoidal profile, in which respect self-evidently the transitions between the cutting edge portions which are angled relative to each other can in turn be of a smaller radius. In the case of the cutting corner 15₂, the end portions of the cutting edges 11 are angled in such a way that they include a larger angle than 60° so that with such a cutting corner it is possible to produce threads whose flank angle is greater than 60°.

In the case of the cutting corner 15₃, the cutting edge 11 is displaced somewhat inwardly behind the end portion so that a smaller angle than 60° is included between the end portions of the cutting edges 11 so that threads with flank angles of less than 60° can be produced with such a cutting corner. Optionally the end portions of the cutting edges 11 could also extend approximately parallel in order for example to produce threads for a spindle drive.

For the purposes of the original disclosure it is noted that all features as can be seen by a man skilled in the art from the present description, the drawing and the appended claims, even if they are described in specific terms only in connection with certain other features, can be combined both individually and also in any combinations with others of the features or groups of features disclosed here insofar as that has not be expressly excluded or technical aspects make such combinations impossible or meaningless. A comprehensive explicit representation of all conceivable combinations of features and emphasis of the independence of the individual features from each other is dispensed with here only for the sake of brevity and readability of the description.

1. A thread milling cutter comprising a main body having a shank, a cutting portion having a cylindrical shape, an axis of rotation, and a plurality of cutting teeth spaced in a peripheral direction and arranged on the cutting portion in at least two different radial planes and extending perpendicularly to the axis of rotation, wherein the cutting portion has at least two seats for receiving a respective standard cutting insert in each of at least two different radial planes, the cutting teeth being formed by cutting corners of the standard cutting inserts.

2. The thread milling cutter according to claim 1, wherein at least three cutting inserts are respectively arranged on a same rotational circle in a radial plane.

3. The thread milling cutter according to claim 1, wherein the cutting inserts are arranged in overall at least three different radial planes.

4. The thread milling cutter according to claim 1, wherein the cutting inserts in the radial planes are arranged in a mutually displaced relationship in the peripheral direction.

5. The thread milling cutter according to claim 1, wherein the cutting inserts include rake surfaces and provided in front of the rake faces of the cutting inserts are chip spaces formed by cavities, which are set back radially with respect to a cylindrical envelope of the cutting portion, a displacement of mutually closest cutting inserts of adjacent radial planes in the radial direction corresponding to a twist angle which is so selected that the chip spaces of the mutually closest cutting inserts arranged in adjacent radial planes overlap in the peripheral direction.

6. The thread milling cutter according to claim 1, wherein the spacing of the radial planes is an integral multiple of one or more standard thread pitches.

7. The thread milling cutter according to claim 1, wherein in a plan view of the rake face the cutting inserts have a shape of an equilateral triangle and are mounted radially in a respective seat.

8. The thread milling cutter according to claim 1, wherein tips of the cutting corners are rounded or trimmed back.

9. The thread milling cutter according to claim 7, wherein axially most forwardly disposed cutting edges of the cutting inserts having a triangular basic shape axially project in a region radially within a profile-forming cutting corner with respect to the main body of the cutting portion.

10. The thread milling cutter according to claim 1, wherein side faces of the cutting inserts are drawn in between adjacent cutting corners in the direction of a center of the cutting insert and/or expanded out from the center.

11. The thread milling cutter according to claim 1, wherein the cutting inserts are double-sided indexable cutting inserts.

12. The thread milling cutter according to claim 1, wherein in a plan view of the rake face the cutting corners overall are a complete profile shape of at least one thread flight and a thread base.

13. The thread milling cutter according to claim 5, wherein the insert seat has a seat face for a contact face of the cutting insert that is opposite to the rake face, wherein the seat face has a seat face portion extending radially outwardly beyond the cylindrical envelope of the cutting portion.

14. The thread milling cutter according to claim 13, wherein the seat face portion is formed by an end face of a web, which peripherally extends in the radial plane and which is interrupted only in a region of the seats and the chip spaces.

15. The thread milling cutter according to claim 1, wherein the cutting teeth of a front radial plane which is further remote from the shank and at least the front radial plane which is most remote from the shank have a small radial projection of 1 to 100 μm in relation to cutting teeth of next following radial planes with respect to the cutting teeth of all radial planes occurring in succession in a direction of the shank to compensate for radial deflection.
